(19) United States
(12) Patent Application Publication
(10) Pub. No.: US 2023/0003255 A1
(43) Pub. Date: Jan. 5, 2023

(54) METHOD FOR PRODUCING A SLIDING LAYER OF A SLIDING-CONTACT BEARING USING AN ALLOY AND/ OR A MATERIAL

(71) Applicant: RENK Aktiengesellschaft, Augsburg (DE)

(72) Inventors: Christoph Hentschke, Hannover (DE); Martin Limmer, Sarstedt (DE); Christian Coninx, Hameln (DE)

(21) Appl. No.: 17/778,613

(22) PCT Filed: Jun. 8, 2020
(86) PCT No.: PCT/EP2020/065762

§ 371 Date: May 20, 2022

(30) Foreign Application Priority Data
Nov. 22, 2019 (DE) 10 2019 131 591.3

(51) Int. Cl. F16C 33/12; F16C 33/14

(52) U.S. Cl. CPC F16C 33/125; F16C 33/14; F16C 2220/20; F16C 2204/34; F16C 2223/80; B33Y 80/00

(57) ABSTRACT

A method for manufacturing a sliding layer of a slide bearing includes applying any of the following alloys and/or materials, namely SnSb8Cu4, SnSb12Cu6Zn, CuSn12Ni2, CuAl10Fe1, tin and aluminum bronzes, aluminum materials and alloys made therefrom, to a base body in a laser-based application process, wherein the alloy and/or material for application is in the form of a powder or compacted powder or as a wire.

### CROSS-REFERENCE TO RELATED APPLICATIONS

This application is a national phase application under 35 U.S.C. § 371 of International Patent Application No. PCT/EP2020/065762, filed Jun. 8, 2020 (pending), which claims the benefit of priority to German Patent Application No. DE 10 2019 131 591.3, filed Nov. 22, 2019, the disclosures of which are incorporated by reference herein in their entirety.

### TECHNICAL FIELD

The invention relates to the use of an alloy and/or a material for producing a slide layer of a slide bearing and a production method of a slide layer of a slide bearing using the alloy and/or the material, in particular tin-based alloys and bronze and aluminum alloys.

### BACKGROUND

For the production of highly stressable metal coatings, which are produced as a composite with metallic substrate materials, special highly stressable metallic materials must be used, which are applied to the metallic substrate materials (base body). Highly stressable tin-based materials with good sliding, running-in, embedding and emergency running properties are frequently used. In addition, additional elements must be used if the coating is subjected to higher thermal loads or if the static and dynamic loads on the coating are high, as in the case of bearings subjected to impact and shock loads. Typical application examples are highly loaded bearings in compressors, pistons and expansion machines and rolling mills.

In hydrodynamic slide bearings with a sliding layer of a tin-based alloy (“white metal”), the alloy is typically applied by a centrifugal or stationary casting process. In this process, the base body is tin-plated beforehand in order to achieve good bonding of the subsequently applied alloy layer.

To achieve a good bond between the metallic layers, pretreatment of the bonding surface of the metallic support body has been necessary up to now because of the adhesion problem. For a composite casting between metallic base bodies such as steel, cast steel, gray cast iron, bronze and tin-containing coating materials, for example, pickling agents and/or tin-plating of the bonding surface are required. This leads to complex, cost-intensive and often environmentally harmful process steps. For some processes and material combinations, additional metallic intermediate layers are necessary, which involves considerable effort.

Currently, such coatings are produced by means of complex casting processes. These require precise temperature control and often pretreatment of the base material with mostly toxic pickling agents, such as zinc chloride compounds. In addition, a castable alloy is required that can be applied to the substrate without segregation or other segregation phenomena. Furthermore, casting processes require defined heating of the base body and defined cooling after pouring to achieve good quality of the crystal structure, high homogeneity and bonding by uniform temperature control in both layers. After application of the tin-containing metal layer, a machining post-treatment is also necessary to give the coating its final shape. This requires the provision of casting equipment and appropriate monitoring and finishing equipment. In practice, it is usually difficult to cast a crystalline homogeneous highly stressable metal coating on complex base bodies with highly fluctuating material thicknesses.

The group of “IWK” alloys are special tin-based alloys for slide bearings with 11-14 percent antimony, 5-7 percent copper, 0.1-3 percent bismuth, 0.1-2 percent zinc and 0.01-0.5 percent tellurium. This group can only be processed to a very limited extent using the conventional centrifugal or stationary casting process, as the tin-plating of the base body is not sufficient to achieve a good bond. A special and complex tinning-galvanizing pretreatment is necessary. For this reason, the “IWK” alloys have not yet become established on the market, despite their outstanding properties.

### SUMMARY

It is an object of the present invention to provide the use of an alloy and/or a material for manufacturing a sliding layer of a slide bearing and a manufacturing method of a sliding layer of a slide bearing using the alloy and/or the material, in particular tin-based alloys, bronze alloys and aluminum alloys, which simplifies the manufacturing process and improves the slide bearing properties.

This object is achieved by the manufacturing methods as described herein.

According to an embodiment of the invention, the use of one of the following alloys and/or materials, namely SnSb8Cu4, SnSb12Cu6Zn, CuSn12Ni2, CuAl10Fe1, tin bronzes and aluminum bronzes, aluminum materials and alloys made therefrom, is provided for producing a sliding layer of a slideslide bearing by means of a laser-based application process of one of these alloys and/or materials to a base body. The alloy and/or the material for application is in the form of a powder or a compacted powder or in wire form.

When using the alloys SnSb8Cu4 and SnSb12Cu6Zn, increased process reliability, increased economy and improved bonding strength are given. The processing of tin bronzes and aluminum bronzes, such as CuSn12Ni2 powder and CuAl10Fe1 powder in laser-based deposition processes enables new sliding layer compositions. These materials have good tribological properties in critical operating conditions. Increased load-bearing capacity, “downsizing” and increased mechanical characteristic values with simultaneously increased temperature conditions are just some of the potentials that can be effectively exploited.

In an advantageous embodiment, it is provided that the alloy is a tin-based alloy containing 11-14 percent antimony, 5-7 percent copper, 0.1-3 percent bismuth, 0.1-2 percent zinc, and 0.01-0.5 percent tellurium.

The “IWK” alloys used can be used without the need for complex pretreatment. The technological properties of the “IWK” alloys, such as strength, toughness, creep resistance and temperature resistance, exceed the previously established white metal alloys. Their use is therefore particularly conceivable under critical operating conditions. The higher load-bearing capacity also allows potentials to be exploited through “downsizing”.

In an embodiment of the invention, it is provided that the particle size of the powder is 1-250 μm. This way, the particle size of the powders used is matched to the processing method and this leads to optimum processing results.

Furthermore, a use is favorable in which the alloy SnSb12Cu6Zn is applied without inoculant and, in a further advantageous variant, it is provided according to the invention that the alloys and/or the material have a reduced proportion of inoculant or no inoculant.

In the case of these alloys, there is the potential, through optional, selective omission of inoculants such as silver, which have a process-securing effect on the casting process due to its relatively slow cooling rates and are therefore necessary, to modify the powders in such a way that good results and microstructure layer compositions can be generated for laser-based deposition processes with their characteristic fast cooling rates. Substitution or omission of inoculants would bring considerable economic advantages.

In a preferred embodiment of the invention, the powder or compacted powder is produced via atomization using one of gas atomization, water atomization, gas/water mixture atomization, or powder production processes, such as a Plasma Rotating Electrode Process (PREP), or friction power-based powder production processes.

Furthermore, according to the invention, a manufacturing process of a sliding layer of a slide bearing using an alloy and/or a material according to the above features, by means of a laser-based application process to a base body is provided. The alloy and/or the material for the application are thereby present in the form of a powder or a compacted powder or also in wire form.

An inverse coating strategy allows significant advantages to be exploited in the manufacture of the product. Micropore-free, cast base bodies, which serve as a functional layer (sliding/wear protection layer) at a later stage, can be coated with any combination of materials. In this way, components can be generated which require less energy density in the manufacturing process, can be produced more quickly and are therefore more cost-efficient, where applicable.

Preferably, the manufacturing process is carried out such that the laser-based deposition method is laser powder cladding or laser wire welding.

In a further advantageous embodiment, it is provided in accordance with the invention that the coating is a sliding layer or wear protection layer and is applied to the base body with a thickness of 0.1-10 mm. It is favorable that the thickness of the sliding layer is varied and adapted to the corresponding application.

It is further advantageous if the coating is produced as a multilayer coating system and single- or multilayer buffer layers made of other materials are incorporated. The advantage of this is that the material properties of the coating are further adapted to and optimized for the particular application.

In an alternative embodiment of the present manufacturing process, it is further provided that CuSn12Ni2 is pulverized and applied in powder form, optionally also in wire form, in the laser-based process, using preheating and/or postheating processes. Since this material is currently only cast conventionally and is therefore not available, a newly available powder for coating is produced which, in accordance with the above features, has very good material properties for a sliding layer of a slideslide bearing.

In one embodiment of the invention, it is provided that base bodies are produced from the alloy with the addition of the material groups tin bronzes, aluminum bronzes and further aluminum alloys. This further improves the bonding of the alloys and/or materials to the base body.

In a preferred embodiment of the invention, the base body is manufactured by means of a casting process or by additive manufacturing, and in an advantageous embodiment of the invention, it is provided that the base body has a planar, cylindrical, convex or concave structure, including the possibility of carrying out an internal or an external coating, respectively. Following their manufacturing process, these base bodies can be coated on one or more sides, as well as internally and externally, with the same, or different, metallic (ferrous and non-ferrous metals) and/or non-metallic powders with a grain size variance of 1-250 micrometers, where applicable using one or more buffer layers, which are also made up of any material systems, by laser powder cladding or laser wire welding. This allows for a multilayerd-ness.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

1-14. (canceled)

15. A hydrodynamic slide bearing, comprising:
a base body;
a sliding layer laser deposited on the base body, the sliding layer comprising tin bronzes, aluminum bronzes, aluminum materials, or alloys made therefrom.

16. The hydrodynamic slide bearing of claim 15, wherein the sliding layer comprises SnSb8Cu4, SnSb12Cu6Zn, CuSn12Ni2, or CuAl10Fe1.

17. The hydrodynamic slide bearing of claim 15, wherein the base body is formed by a casting process or by an additive manufacturing process.

18. The hydrodynamic slide bearing of claim 15, wherein the sliding layer comprises a tin-based alloy containing 11-14 percent antimony, 5-7 percent copper, 0.1-3 percent bismuth, 0.1-2 percent zinc, and 0.01-0.5 percent tellurium by mass.

19. The hydrodynamic slide bearing of claim 15, wherein the sliding layer was laser-deposited as a material in powder form, and the powder grain limit/grain size of the powder is in the range of 1 μm to 250 μm, inclusive.

20. The hydrodynamic slide bearing of claim 15, wherein the sliding layer comprises SnSb12Cu6Zn alloy applied without inoculant.

21. The hydrodynamic slide bearing of claim 15, wherein the alloys and/or materials have a reduced proportion of inoculant, or have no inoculant.

22. The hydrodynamic slide bearing of claim 15, wherein the powder or compacted powder is produced by atomization means of one of gas atomization, water atomization or gas/water mixture atomization or a powder production process Plasma Rotating Electrode Process (PREP) or friction power based powder production processes.

23. A method of producing a sliding layer of a hydrodynamic slide bearing, the method comprising:
applying a material to a base body by laser-based deposition;
wherein the material for application to the base body is an alloy or material in the form of a powder or a compacted powder, or in wire form.

24. The method of claim 23, wherein the material applied by laser deposition comprises tin bronzes, aluminum bronzes, aluminum materials, or alloys made therefrom.

25. The method of claim 24, wherein the material comprises SnSb8Cu4, SnSb12Cu6Zn, CuSn12Ni2, or CuAl10Fe1.

26. The method of claim 23, wherein the laser-based deposition method is laser powder cladding or laser wire welding.

27. The method of claim 23, wherein applying the material to the base body comprises applying the material to achieve a thickness of 0.1 mm to 10 mm, inclusive.

28. The method of claim 23, further comprising:
incorporating single-layer or multi-layer buffer layers of additional material such that the sliding layer is produced as a multi-layer coating.

29. The method of claim 23, wherein:
the applied material is CuSn12Ni2 that is pulverized and applied in powder form or in wire form in the laser-based method; and
the method further comprises at least one of preheating or post-heating the CuSn12Ni2 material.

30. The method of claim 23, wherein base bodies are manufactured of the alloy with the addition of the material groups tin bronzes and aluminum bronzes and further aluminum alloys.

31. The method of claim 23, wherein the base body is manufactured by a casting process or by an additive manufacturing process.

32. The method of claim 23, wherein the base body has a planar, cylindrical, convex or concave structure.
